(19) United States
(12) Patent Application Publication
(10) Pub. No.: US 2011/0224817 A1
(43) Pub. Date: Sep. 15, 2011

(54) AUTOMATICALLY SOLVING A TRUCK CONFIGURATION PROBLEM

(75) Inventors: Bella Dubrov, Nahariya (IL); Yehuda Naveh, Haifa (IL); Shlomo Hoory, Haifa (IL); Alfons Steinhoff, Herrenberg (DE); Ute Twisselmann, Hamburg (DE)

(73) Assignee: International Business Machines Corporation, Armonk, NY (US)

(21) Appl. No.: 12/720,693

(22) Filed: Mar. 10, 2010

(51) Int. Cl. G06F 17/50; G06F 17/11

(52) U.S. Cl. 700/104; 703/2; 703/8

(57) ABSTRACT

A truck configuration satisfying a truck configuration problem is automatically determined. The truck configuration problem is transformed to a target function, outputting values indicative of configurations satisfying the truck configuration problem. Stochastic local search methods are applied on the target function to determine the truck configuration. Preprocessing may be performed to improve efficiency, performance or the like of the stochastic local search methods. The truck configuration problem may be obtained from several sources, which may be independent of one another.

### BACKGROUND

The present disclosure relates to automatic determination of a solution to a configuration problem, in general, and to automatic determination of a solution to a truck configuration problem in particular.

A configuration problem may comprise a set of possible components that may be utilized to produce an item, such as a computerized device, an automobile or a truck. The configuration problem may define constraints over the possible components, such as for example a diameter of a tire may be required to be proportional to a diameter of a rim.

A truck configuration problem is specifically a difficult configuration problem. It involves a big amount of different components, such as for example six thousand different components. A client, such as a company purchasing a truck, may prefer one is component over another. However, modifying one component in a configuration of a truck may induce modification of other components which are related to the component either directly or indirectly through one or more constraints. As the cost of a truck is generally substantial, clients may desire to have some control over a significant portion of the components, such as for example by selecting a particular component, requiring a component have a predetermined characteristic or the like. Comparing to a car configuration problem, in which the client has some control over a non-significant portion of the components, such as fifteen components, the truck configuration problem is much more complicated and complex, since clients may have control over a significant number of components, such as for example over three hundred components. Clients may further have control over properties of different components. For example, in some cases, a client may define that the truck should comprise a storage compartment capable of maintaining a predetermined temperature, such as for example minus four degrees Celsius.

### BRIEF SUMMARY OF THE INVENTION

One exemplary embodiment of the disclosed subject matter is a computerized apparatus having a processor comprising: a truck configuration problem obtainer configured to obtain a truck configuration problem; a target function determinator configured to determine a target function based on the truck configuration problem obtained by the truck configuration problem obtainer, a value outputted by the target function in respect to a configuration is indicative of the configuration satisfying the truck configuration problem; and a stochastic local search module configured to perform a stochastic local search to determine a solution such that the target function is at an extremum value in the solution.

Another exemplary embodiment of the disclosed subject matter is a method for determining a satisfying solution to a truck configuration problem, the method is performed in a computerized environment, the method comprising: obtaining a truck configuration problem; determining a target function based on the truck configuration problem, a value of the target function is indicative of a configuration satisfying the truck configuration problem; performing a stochastic local search to determine a solution such that the target function is at an extremum value in the solution; and whereby a set of constraints represented by the truck configuration problem is transformed to the configuration satisfying the truck configuration problem.

Yet another exemplary embodiment of the disclosed subject matter is a computer program product comprising: a computer readable medium; a first program instruction for obtaining a truck configuration problem; a second program instruction for determining a target function based on the truck configuration problem, a value of the target function is indicative of a configuration satisfying the truck configuration problem; a third program instruction for performing a stochastic local search to determine a solution such that the target function is at an extremum value in the solution; wherein the first, second and third program instructions are stored on the computer readable medium.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computerized environment in which the disclosed subject matter is used, in accordance with some exemplary embodiments of the subject matter;

FIG. 2 shows a block diagram of a truck configuring device in accordance with some exemplary embodiments of the disclosed subject matter;

FIG. 3 shows a flowchart diagram of a method in accordance with some exemplary embodiments of the disclosed subject matter; and

FIG. 4 shows a block diagram of a truck configuring device in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to provide an automatic solution to a truck configuration problem. Another technical problem dealt with by the disclosed subject matter is to enable a client to control over a significant portion of a truck configuration. Yet another technical problem dealt with by the disclosed subject matter is to automatically prefer a first solution to the truck configuration problem over a second solution to the truck configuration problem.

One technical solution is utilizing a stochastic local search module to provide a solution to a target function. The target function may be configured to include constraints of the truck configuration problem. The target function may be configured to output an extremum value, such as for example a minima value, in response to a valid configuration. The target function may be configured to output a first value and a second value in respect to two valid configurations, such that a lower value is indicative of a preferred solution between the two solutions. The target function may be configured to output a tuple comprising two values: a first value indicative of a configuration holding the constraints of the configuration problem, a second value indicative of a configuration holding a number of optional preferences that may be used for optimization. Another technical solution is to obtain a truck configuration problem from a multitude of entities, such as a client, an engineering department, a marketing department and the like. Yet another technical solution is to perform preprocessing on a target function to modify it such that it may be better suited for stochastic local search methods.

One technical effect of utilizing the disclosed subject matter is enabling a client to have control over a significant number of components in a truck. Another technical effect of utilizing the disclosed subject matter is providing a target function with relatively shallow local extremum. Yet another technical effect of utilizing the disclosed subject matter is enabling an automatic procedure to solve the truck configuration problem in a reasonable amount of time. Moreover, the solution may be optimized in respect to an optimization function.

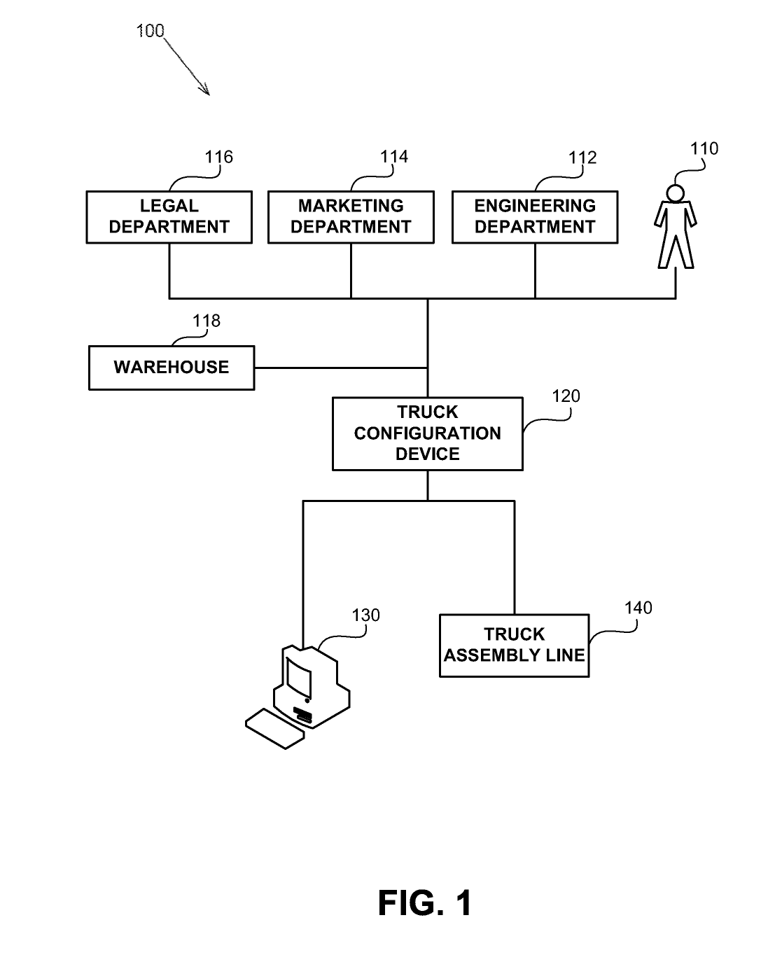

Referring now to FIG. 1 showing a computerized environment in which the disclosed subject matter is used, in accordance with some exemplary embodiments of the subject matter. A computerized environment 100 may comprise a truck configuration device 120 configured to obtain a truck configuration problem and determine a truck configuration in accordance with constraints defined by the truck configuration problem. The truck configuration problem may comprise constraints regarding a type of component, a parameter of component or the like. For example, a tire may be selected from a set of predetermined tires, such as for example provided by different vendors, having different costs, having different parameters or the like. Several types of wheels may be used, each associated with a rim. One or more constraints may be designed to verify that the rim and tire match, such as for example by requiring the rim and the tire have associated diameters, widths or the like.

The truck configuration problem may comprise portions provided by one or more entity such as a client 110 or a customer, an engineering department 112, a marketing department 114, a legal department 116, a warehouse 118 and other departments or entities. A portion may comprise: a variable, such as a variable corresponding to a parameter of a component; a constraint regarding a value of one or more variables; an objective function for optimization; or the like. Two entities may provide portions from different locations or using different means, such as a terminal, a Personal Computer (PC), a Personal Digital Assistant (PDA), a mobile device, a laptop computer, a written form, a printout form or the like. An entity may provide information regarding only a portion of components of a truck, such as for example the client 110 may provide constraints regarding about three hundred component. A second entity may provide constraints regarding another set of components, which may or may not include some components restricted by the constraints provided by the entity. In an exemplary embodiment, the client 110 may not provide information regarding additional variables that were not defined by other entities, such as the engineering department 112.

The engineering department 112 may provide constraints regarding integration of different components; constraints regarding load associated with a component, such as maximal load allowed, minimal load allowed, average load, and similar constraints. The marketing department 114 may provide constraints regarding prices and marketing of components such as for example providing a range of prices to a component based on other configurations, restricting sale of a component to be sold with another component or the like. The legal department 116 may provide constraints regarding legal obligations, such as for example restricting usage of products in different countries, continents, districts or areas, using one component with another component and the like; constraints regarding liability, such as providing a safety mechanism when using a predetermined component or when providing a truck to a predetermined area and the like. The warehouse 118 may provide constraints regarding an inventory of a component or the like. The client 110 may provide constraints regarding a predetermined component, a price range of a truck or a predetermined set of one or more components, a predetermined parameter of a configuration such as for example a number of valves in an engine, or the like.

In some exemplary embodiments, an entity, such as for example the client 110, may provide a mandatory constraint which must be held by a truck configuration. The entity may provide an optional constraint which may be optionally held by the truck configuration. The optional constraint may be a constraint that is preferably held, but may be nonetheless violated. The optional constraint may be associated with an objective function.

The truck configuration device 120 may determine a truck configuration problem based on the constraints obtained from the one or more entities. The truck configuration device 120 may provide an output to a user using a terminal 130 such as a PC, a PDA, a mobile device, a laptop computer or the like. The output may be provided by a list of components. In some cases, a summary of a predetermined portion of the components may be showed, such as most expensive components, most interesting components to the client 110 or the like. The client 110 may view a configuration provided by the truck configuration device 120 and determine to accept it or reject it. The client 110 may modify the constraints and utilize the truck configuration device 120. The client 110 may direct the truck configuration device 120 to determine a different configuration.

In some exemplary embodiments, the truck configuration device 120 may dispatch a determined configuration to a truck assembly line 140, that may assemble a truck based on the determined configuration. The determined configuration may be sent, transmitted or otherwise dispatched in response to the client 110 approving the determined configuration.

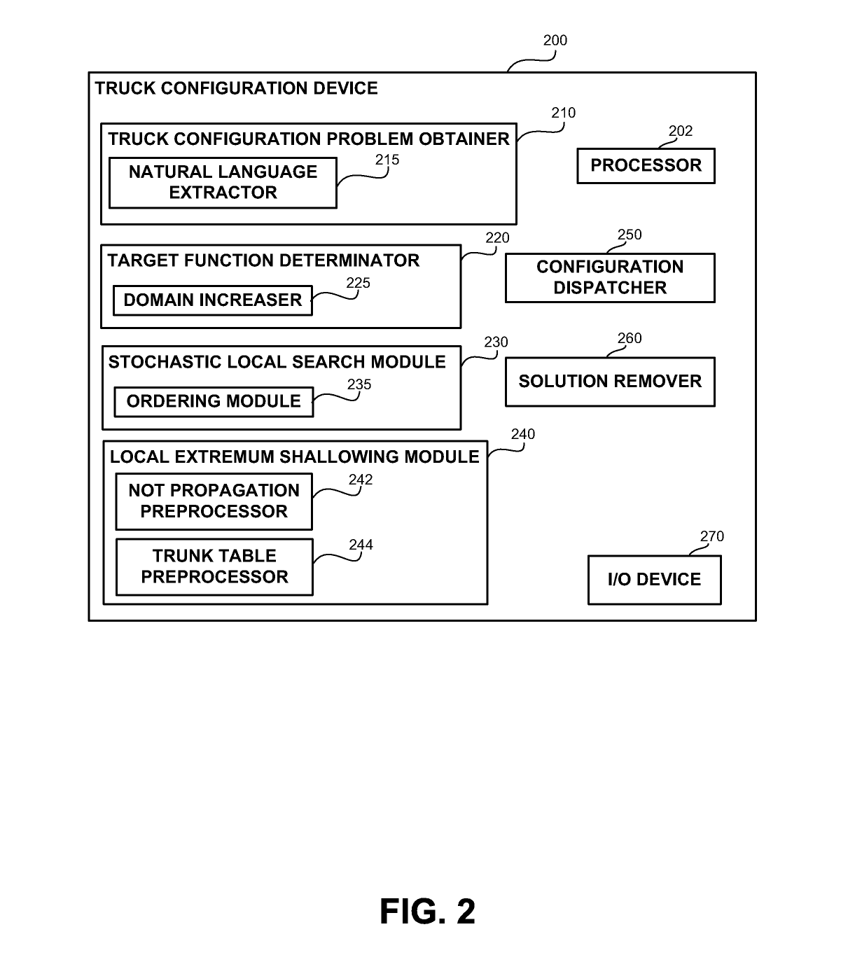

Referring now to FIG. 2 showing a block diagram of a truck configuration device in accordance with some exemplary embodiments of the disclosed subject matter. A truck configuration device 200, such as 120 of FIG. 1, may comprise a truck configuration problem obtainer 210, a target function determinator 220 and a stochastic local search module 230.

The truck configuration problem obtainer 210 may receive, retrieve or otherwise obtain a truck configuration problem from one or more entities such as for example the client 110, the engineering department 112, the marketing department 114, the legal department 116, the warehouse 118 and the like. The truck configuration problem obtainer 210 may utilize an I/O device 270 to obtain the truck configuration problem.

In some exemplary embodiments, the truck configuration problem obtainer 210 may comprise a natural language extractor 215. The natural language extractor 215 may determine a constraint based on a portion of a sentence written in natural language, such as for example, “a diameter of a wheel is equal 48 inches”. In some exemplary embodiments, in lieu of extracting constraints from natural language per se, the natural language extractor 215 may extract constraint from a text written in domain specific formal description language. It will be noted the domain specific formal description language may configured to describe the truck configuration problem.

In some exemplary embodiments, the target function determinator 220 may determine a target function based on the truck configuration problem obtained by the truck configuration problem obtainer 210. The target function may be configured to provide a lower value to a first configuration in respect to a second configuration in case the first configuration holds more constraints of the target configuration problem than the second configuration. For example, in case there are ten constraints, a first configuration holding five constraints is assigned a lower value than a second configuration holding two constraints. In an exemplary embodiment, a configuration holding all constraints is assigned a predetermined value, such as for example zero. In an exemplary embodiment, for each constraint not held by a configuration a value provided by the target function increases. For example, the value of a configuration holding four constraints out of ten constraints, and thus not holding six constraints, may be six. It will be noted that equivalent target functions may be used, such as for example a function which provides a highest value in case all constraints are held. As another example, a target function may provide values which may be ordered in a predetermined order, wherein the order of the values may induce preference of a first configuration associated with a first value over a second configuration associated with a second value. In yet additional exemplary embodiments, the target function may sum a plurality of cost functions of violated constraints, wherein each cost function may be associated with a different violated constraint. Other exemplary target functions may be utilized.

In some exemplary embodiments, the target function may provide a tuple of two values for each constraint. A first value of the tuple may be associated with mandatory constraints. A second value of the tuple may be associated with optional constraints. For example, a configuration holding two mandatory constraints out of ten mandatory constraints and holding three constraints out of four optional constraints may be associated by the target function with the tuple (eight, one).

In some exemplary embodiments, the target function determinator 220 may comprise a domain increaser 225. The domain increaser 225 may be configured to increase a domain of a variable associated with a component. For example, a variable may be associated with a radio component of the truck. A value of the variable may be selected from a predetermined domain, such as a radio domain comprising a value corresponding to each type of radio that may be selected. The domain increaser 225 may modify a domain, such as the radio domain, to further include an additional value representing not providing any component. For example, in some exemplary embodiments, a configuration may not include any radio. A value of zero may be utilized to indicate that no component is selected in the configuration. It will be noted that the truck configuration problem may comprise one or more constraints requiring selection of predetermined component. For example, a truck configuration problem may comprise a constraint requiring selection of a tire, an engine, a gear or the like.

The stochastic local search module 230 may be configured to perform a stochastic local search in respect to a target function. The stochastic local search module 230 may be configured to determine an extremum in the target function. The stochastic local search module 230 may be configured to initiate a search from a configuration, such as a predetermined configuration, an initial configuration or the like. The stochastic local search module 230 may be configured to iteratively improve a value of the target by modifying a portion of a configuration. It will be noted that a value of the target function may be considered improved if it is reduces, increases or the like, based on a predetermined order, such as for example Euclidean order. The stochastic local search module 230 may be configured to halt in case an optimized value is determined. In some exemplary embodiments, an optimized value is found in the minima in the target configuration. The optimized value may correspond to an optimal configuration which may be a configuration that is configured to hold a maximal number of constraints. The optimal configuration may be evaluated to determine whether all mandatory constraints are held by the optimized configuration. In an exemplary embodiment, the stochastic local search module 230 may move from one configuration to another configuration until a configuration deemed optimal is found or until a bound on a resource utilized by the stochastic local search module 230 is reached, such as for example exhausting allocated memory or elapsed time reaches a bound. In some exemplary embodiments, the stochastic local search module 230 may move from a first configuration to a second configuration based on a predetermined neighborhood relation, such as for example by modifying a value of a single variable in the configuration.

The stochastic local search module 230 may be configured to determine the extremum based on a predetermined order, such as for example lexicographical order or the like. An ordering module 235 may be utilized by the stochastic local search module 230 to determine an order between two values of the target function. The ordering module 235 may utilize lexicographical order between a first tuple and a second tuple. For example, the first tuple may be ordered before the second tuple based on an order of the first elements of both tuples, based on a first predetermined order. In case the first predetermined order cannot determine precedent to either values, the tuples may be ordered based on a relative order between the values of the second elements of the tuples. It will be noted that lexicographical order may be utilized to give precedence to configurations that hold more mandatory constraints than other constraints. The lexicographical order may be utilized to give prefer a configuration that holds all mandatory constraints but few optional constraints over a configuration that holds all constraints but one mandatory constraint. By utilizing the lexicographical order, the stochastic local search module 230 may determine an optimal configuration such that when possible, the optimal configuration prefers to hold a mandatory constraint over holding one or more optimal constraints.

In some exemplary embodiments, the truck configuration device 200 may comprise a configuration dispatcher 250. The configuration dispatcher 250 may send, transmit or otherwise dispatch a configuration, such as the configuration determined by the stochastic local search module 230. The configuration dispatcher 250 may utilize the I/O device 270 to dispatch the configuration. The configuration may be dispatched to a truck assembly line, such as 140 of FIG. 1.

In some exemplary embodiments, the I/O device 270 may be utilized to notify a user, such as the client 110, of the configuration determined by the truck configuration device 200. The user may be notified via a terminal, such as 130 of FIG. 1. The user may accept or reject the configuration. In some exemplary embodiments, the user may modify the truck configuration problem such that the configuration may not be selected. For example, in case the user determines that configuration violates a constraint the user did not previously introduce, the user may modify the truck configuration problem.

In some exemplary embodiments, the user may instruct the truck configuration device 200 to determine a different configuration without modifying the truck configuration problem. A solution remover 260 comprised by the truck configuration problem 200 may modify the truck configuration problem such that a predetermined configuration does not satisfy the truck configuration problem. The solution remover 260 may introduce a constraint requiring that at least one of the components is different that a corresponding component in the predetermined configuration. For example, in case a predetermined configuration is A=a, B=b, C=c, D=d, where A,B,C,D are components of the truck and a,b,c,d are values of the components that are used in the predetermined configuration, the truck configuration problem may be modified to further include a constraint requiring (A!=a OR B!=b OR C!=c OR D!=d).

In some exemplary embodiments, the truck configuration device 200 comprises a processor 202. The processor 202 may be a Central Processing Unit (CPU), a microprocessor, an electronic circuit, an Integrated Circuit (IC) or the like. The processor 202 may be utilized to perform computations required by the truck configuration device 200 or any of it subcomponents.

In some exemplary embodiments, the truck configuration device 200 may comprise a local extremum shallowing module 240. In some exemplary embodiments, the local extremum shallowing module 240 may modify the target function such that an optimized configuration in respect to the target function is also an optimized configuration in respect to the modified target function and vice-versa. In some exemplary embodiments, the local extremum shallowing module 240 may modify the target function such that the ordering of configurations determined by the target function is preserved by the modified target function. For example, in case a first configuration is preferred over a second configuration based on the target function, the first configuration is also preferred over the second configuration based on the modified target function. It will be noted that a first and second that are assigned a same value by the target function (and therefore none of them is preferred over the other based on the target function), may be assigned a different value by the modified target function.

The local extremum shallowing module 240 may be configured to determine the modified target such that a local extremum of the modified target function is “shallower” than a corresponding local extremum of the target function. As the stochastic local search module 230 may be configured to gradually improve a value of the target function, identifying a local extremum of a function in a relatively fast manner is one objective of the stochastic local search module 230. Shallowing a local extremum may serve this objective by enabling the stochastic local search module 230 to more easily identify a modification to a configuration that improves the outputted value of the target function. It will be noted that a shallower local extremum enables the stochastic local search module 230 to identify the local extremum in a relatively fast manner, and enable the stochastic local search module 230 to continue searching for global extremum.

The local extremum shallowing module 240 may be configured to determine the modified target such that there are less local extremums in the modified target function than there are in the target function. As the stochastic local search module 230 may be configured to gradually improve a value of the target function, each local extremum of a function may be an extremum of the function and therefore may require some computation. Reducing a number of extremums may improve a performance of the stochastic local search module 230.

In some exemplary embodiments, the local extremum shallowing module 240 may be configured to shallow local extremums of a predetermined type, such as for example local minimums. The predetermined type may be associated with an ordering of values of the target function. For example, if a lower value is considered a better value, the local extremum shallowing module 240 may shallow local minimums and may reduce a number of local minimums.

In some exemplary embodiments, the local extremum shallowing module 240 may comprise a not propagation preprocessor 242. The not propagation preprocessor 242 may be configured to modify a target function by propagating a logical not operator. For example, a constraint may be “not (A!=B)”. A portion of a target function associated with the original constraint may be cost (not(A!=B))=0 iff cost (A!=B)!=0 and cost(not(A!=B))=M iff cost (A!=B)=0, where M is a predetermined positive constant. The target function (named “cost”) outputs a lowest value when the constraint is held. However, the target function is steep and modifying a bit of A or B may either not modify the value of the target function or may modify it to the optimal value. The not propagation preprocessor 242 may identify the constraint and propagate the not into the brackets, such that the constraints is modified to “A=B”. Both the original and modified constraints are equivalent. However, propagating the logical not into the brackets may improve a performance of the stochastic local search module 230. For example, referring again to the example above, the modified target function cost (A=B) may be for example ∥A−B∥, where the operator “∥ ∥” may denote an absolute value, a mean-square-root (sqrt(\sum(Ai−Bi)̂2)), a Hamming distance between the vectors represented by A and B or the like. The modified target function has a relatively smooth gradient. The modified target function may become gradually smaller when A nears B until reaching an optimal value when A and B are identical. This provides a shallow (non-steep) minima.

In some exemplary embodiments, the local extremum shallowing module 240 may comprise a trunk table preprocessor 244. In some exemplary embodiments, the truck configuration problem may be built from many common structures, which may be unique to this problem. For example, a multi-layered table may define which types of tires may fit which types of rims. The trunk table preprocessor 244 may preprocess the problem to assist in defining a relatively smooth cost function. The trunk table preprocessor 244 may be configured specifically to provide the cost function associated with the multi-layered table. The trunk table preprocessor 244 may be manually tuned to provide a relatively smooth cost function associated with the specific structure utilized by common types of truck configuration problems. For example, some engineering department may utilize a specific structure, which may be reused in different truck configuration problems, such as for example problems associated with different clients.

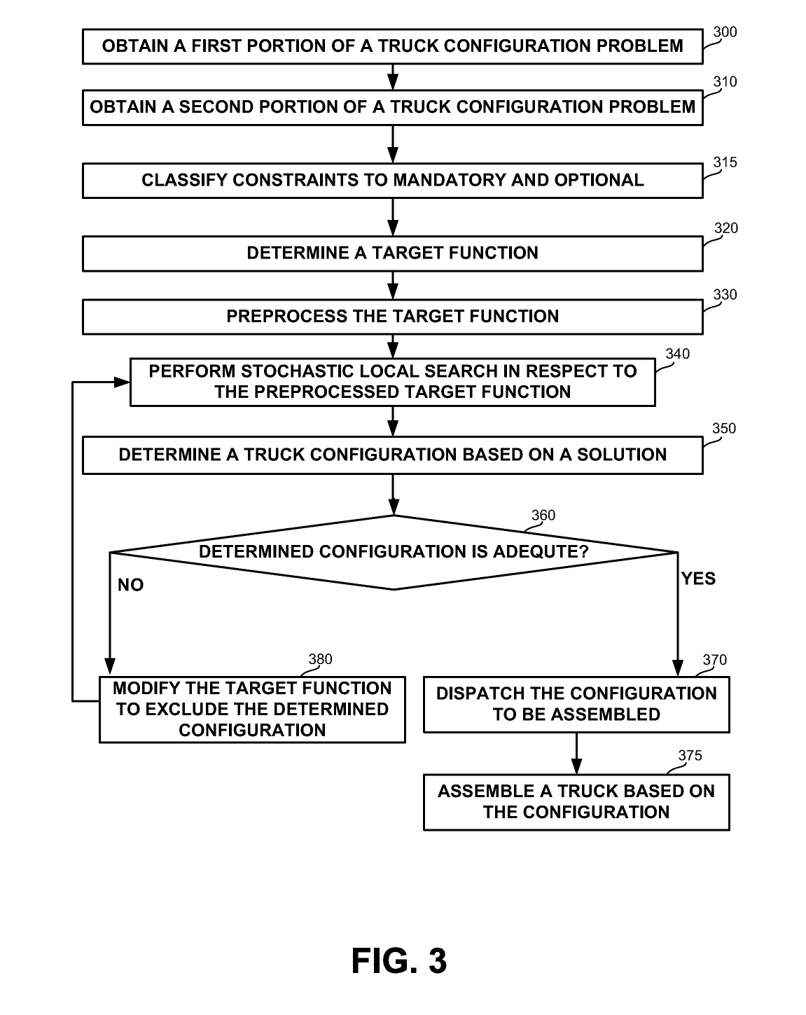

Referring now to FIG. 3 showing a flowchart diagram of a method in accordance with some exemplary embodiments of the disclosed subject matter.

In step 300, a first portion of a truck configuration problem may be received, retrieved or otherwise obtained. A truck configuration problem obtainer, such as 210 of FIG. 2, may obtain the first portion.

In step 310, a second portion of a truck configuration problem may be received, retrieved or otherwise obtained. A truck configuration problem obtainer, such as 210 of FIG. 2, may obtain the second portion. It will be noted that in some exemplary embodiments, additional portions are obtained. Each portion may be obtained from a different entity. Some of the portions may be obtained using a natural language extractor 215. In some exemplary embodiments, a single portion is obtained.

In step 315, constraints may be classified into mandatory constraints and optional constraints. The constraints may be classified by a target function determinator, such as 220 of FIG. 2.

In step 320, a target function may be determined based on the truck configuration problem. The target function may be determined by a target function determinator, such as 220 of FIG. 2. The target function may provide a tuple of two values, a first value indicative of holding mandatory constraints and a second value indicative of holding optional constraints.

In step 330, the target function may be preprocessed. The target function may be preprocessed such to improve a performance of a stochastic local search algorithm searching for an extremum of the target function. The preprocessing may be performed by a local extremum shallowing module, such as 240 of FIG. 2. In some exemplary embodiments, the truck configuration problem may be preprocessed prior to determining the target function.

In step 340, a stochastic local search algorithm may be applied in respect to the preprocessed target function in order to determine a solution outputting an optimal value. The stochastic local search algorithm may be performed by a stochastic local search module, such as 230 of FIG. 2.

In step 350, a determination of a truck configuration may be made based on the solution. The determination may be made by a truck configuration device, such as 200 of FIG. 2.

In step 360 a determination whether the truck configuration is adequate may be performed. The determination may be performed by a truck configuration device, by a user such as client 110 of FIG. 1 or the like.

In response to a determination that the truck configuration is not adequate step 380 may be performed. In step 380 the target function may be modified. In some exemplary embodiments, the target function may be modified by a solution remover, such as 260 of FIG. 2, to exclude the truck configuration. In some exemplary embodiments, the target function may be modified to relax one or more constraints, such that a configuration holding all the mandatory constraints may be determined by the stochastic local search algorithm. In response to modifying the target function, step 340 may be performed in respect to the modified target function.

In response to a determination that the truck configuration is adequate, the truck configuration may be dispatched to be assembled in step 370. The truck configuration may be dispatched manually, semi-automatically or automatically. Dispatching may be performed by a configuration dispatcher, such as 260 of FIG. 2.

In step 375, a truck may be assembled based on the truck configuration. The truck may be assembled in a truck assembly line, such as 140 of FIG. 1.

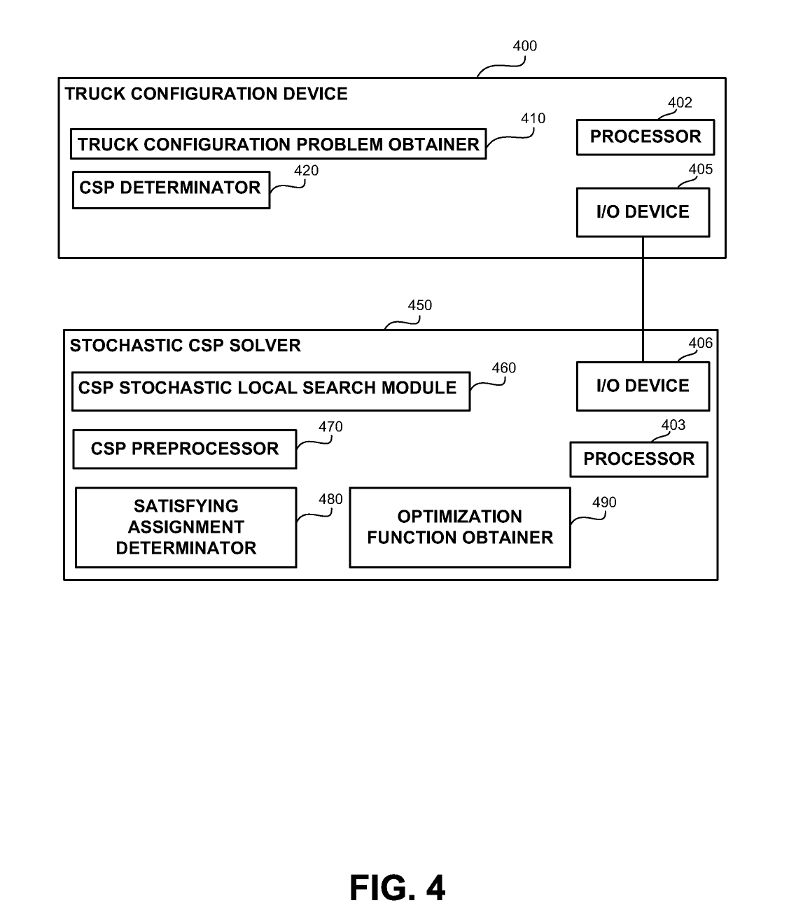

Referring now to FIG. 4 showing a block diagram of a truck configuring device in accordance with some exemplary embodiments of the disclosed subject matter.

A truck configuration device 400, such as 120 of FIG. 1, may comprise a processor 402, such as processor 202 of FIG. 2, an I/O device 405, such as I/O device 270 of FIG. 2, a truck configuration problem obtainer 410, such as a truck configuration problem obtainer 210 of FIG. 2. The truck configuration device 400 may comprise a Constraint Satisfaction Problem (CSP) Determinator 420. The CSP Determinator 420 may determine a CSP based on the truck configuration problem obtained by the truck configuration problem obtainer 410. The CSP may comprise variables, domains associated with variables, constraints and the like. The CSP Determinator 420 may determine a CSP comprising a variable associated with a component or characteristic of a component. The CSP determinator 420 may determine a CSP comprising a domain associated with a variable based on the possible values of the variable, as described by the truck configuration problem. The CSP determinator 420 may determine a constraint on a value of a variable based on the truck configuration problem. In some exemplary embodiments, the constraint may be constrain values of additional variables as well.

The truck configuration device 400 may utilize a stochastic CSP solver 450 to solve the CSP. The truck configuration device 400 may utilize the I/O device 405 to transmit, send or otherwise transfer the CSP to the stochastic CSP solver 450. The I/O device 405 may utilize an Application Programming Interface (API) of the stochastic CSP solver 450 to initiate an action by the stochastic CSP solver 450.

The stochastic CSP solver 450 may comprise an I/O device 406 which may be similar to I/O device 405; a processor 403, which may be similar to processor 403.

The stochastic CSP solver 450 may comprise a CSP preprocessor 470 for performing a preprocessing of the CSP. The CSP may be preprocessed such to improve performance of a stochastic local search algorithm. The preprocessing may be similar to that done by a local extremum shallowing module, such as 240 of FIG. 2.

The stochastic CSP solver 450 may comprise a CSP stochastic local search module 460 configured to perform a stochastic local search over a CSP problem. The CSP stochastic local search module 460 may utilize an optimization function obtainer 490. The optimization function obtainer 490 may determine a target function, such as determined by a target function determinator 220 of FIG. 2. The target function may be utilized by the CSP stochastic local search module 460 to determine whether modifying a configuration is an improvement or not. Determining whether an improvement is made may assist in solving a CSP problem using stochastic local search methods.

A stochastic CSP solver 450 may comprise a satisfying assignment determinator 480 configured to determine whether a configuration satisfies a CSP. The satisfying assignment determinator 480 may be utilized by the CSP stochastic local search module 460 to determine whether an optimal configuration satisfies at least the mandatory constraints of the CSP.

The stochastic CSP solver 450 may comprise a domain increaser (not shown) such as 225 of FIG. 2, a configuration dispatcher (not shown) such as 250 of FIG. 2, a solution remover (not shown) such as 260 of FIG. 2 or the like.

It will be noted that a truck may be a relatively expensive product comprising a significant number of components. A client may desire to have control over a significant portion of characteristics of a truck. The constraints dictated by the client together with inventory constraints and engineering constraints and other constraints may be significant. It is desirable to utilize the disclosed subject matter to automatically provide a configuration holding all mandatory constraints of the truck configuration problem within a reasonable amount of time. Automatic determination of a truck configuration has been a long felt need that, although researched, a reasonable solution to this problem was not provided prior to the invention of the disclosed subject matter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized apparatus having a processor comprising:
a truck configuration problem obtainer configured to obtain a truck configuration problem;
a target function determinator configured to determine a target function based on the truck configuration problem obtained by said truck configuration problem obtainer, a value outputted by the target function in respect to a configuration is indicative of the configuration satisfying the truck configuration problem; and a stochastic local search module configured to perform a stochastic local search to determine a solution such that the target function is at an extremum value in the solution.

2. The computerized apparatus of claim 1, wherein said truck configuration problem obtainer is configured to obtain a first portion of the truck configuration problem from a first entity; and said truck configuration problem obtainer is configured to obtain a second portion of the truck configuration problem from a second entity.

3. The computerized apparatus of claim 2, wherein the first entity and second entity are selected from the group consisting of a customer, an engineering department, a marketing department, a legal department and a warehouse.

4. The computerized apparatus of claim 2, wherein the first entity is different than the second entity.

5. The computerized apparatus of claim 1, wherein said truck configuration problem obtainer comprising a natural language extractor configured to determine a portion of the truck configuration problem based on a natural language description.

6. The computerized apparatus of claim 1, wherein the value outputted by the target function is a tuple comprising a mandatory configuration value and an optimal configuration value, the mandatory configuration value is indicative of the configuration satisfying a mandatory requirement defined by the truck configuration problem, the optimal configuration value is indicative of the configuration satisfying an optional requirement defined by the truck configuration problem.

7. The computerized apparatus of claim 6, wherein said stochastic local search module comprising an ordering module configured to determine a lexicographical order between a first value outputted by the target function and a second value outputted by the target function, the lexicographical order is based on a first order between mandatory requirements and a second order between optional requirements.

8. The computerized apparatus of claim 1 further comprising a local extremum shallowing module configured to modify the truck configuration problem to a shallow truck configuration problem.

9. The computerized apparatus of claim 8, wherein said local extremum shallowing module comprises a not propagation preprocessor.

10. The computerized apparatus of claim 8, wherein said local extremum shallowing module comprises a truck table preprocessor.

11. The computerized apparatus of claim 1, wherein said target function determinator comprising a domain increaser.

12. The computerized apparatus of claim 1 further comprising a configuration dispatcher configured to dispatch a truck configuration, the truck configuration is determined based on the solution provided by said stochastic local search module.

13. The computerized apparatus of claim 1 further comprising a solution remover configured to modify the target function to exclude the solution.

14. A method for determining a satisfying solution to a truck configuration problem, the method is performed in a computerized environment, said method comprising:
obtaining a truck configuration problem;
determining a target function based on the truck configuration problem, a value of the target function is indicative of a configuration satisfying the truck configuration problem;
performing a stochastic local search to determine a solution such that the target function is at an extremum value in the solution; and
whereby a set of constraints represented by the truck configuration problem is transformed to the configuration satisfying the truck configuration problem.

15. The method of claim 14, wherein said obtaining the truck configuration problem comprises:
obtaining a first portion of the truck configuration problem from a first entity; and
obtaining a second portion of the truck configuration problem from a second entity.

16. The method of claim 14, wherein the value outputted by the target function is a tuple comprising a mandatory configuration value and an optimal configuration value, the mandatory configuration value is indicative of the configuration satisfying a mandatory requirement defined by the truck configuration problem, the optimal configuration value is indicative of the configuration satisfying an optional requirement defined by the truck configuration problem.

17. The method of claim 16, wherein said performing the stochastic local search comprises determining an order between a first value outputted by the target function in respect to a first configuration and a second value outputted by the target function in respect to a second configuration, the order is determined based on a lexicographical order between the first value and the second value, the lexicographical order is based on a first order between mandatory configuration values and a second order between optimal configuration values.

18. The method of claim 14 further comprises preprocessing the target function to provide a shallower target function.

19. The method of claim 18, wherein said preprocessing the target function comprises performing truck table preprocessing.

20. The method of claim 14, wherein said determining the target function comprises increasing a domain of a variable associated with the target function.

21. The method of claim 14 further comprises ordering a truck in accordance with the solution.

22. The method of claim 14 further comprises assembling a truck in accordance with the solution, whereby a set of components are coupled to one another, the set of components is transformed into a truck.

23. A computer program product comprising:
a computer readable medium;
a first program instruction for obtaining a truck configuration problem;
a second program instruction for determining a target function based on the truck configuration problem, a value of the target function is indicative of a configuration satisfying the truck configuration problem;
a third program instruction for performing a stochastic local search to determine
a solution such that the target function is at an extremum value in the solution;
wherein said first, second and third program instructions are stored on said computer readable medium.
